(19) United States
(12) Patent Application Publication
(10) Pub. No.: US 2026/0056011 A1
(43) Pub. Date: Feb. 26, 2026

(54) METHOD OF CONFIRMING SWELLING OF A BATTERY

(71) Applicant: Samsung SDI Co., Ltd., Yongin-si (KR)

(72) Inventor: Joohyoung Lee, Yongin-si (KR)

(73) Assignee: Samsung SDI Co., Ltd., Yongin-si (KR)

(21) Appl. No.: 19/306,113

(22) Filed: Aug. 21, 2025

(30) Foreign Application Priority Data
Aug. 21, 2024 (KR) 10-2024-0112208

(51) Int. Cl. G01B 11/16; G06F 11/30

(52) U.S. Cl. CPC G01B 11/16; G06F 11/3058

(57) ABSTRACT

The present disclosure relates to a method of confirming a battery swelling phenomenon, and more particularly, to a method of confirming a battery swelling phenomenon by using a fiducial marker or product labeling. The method of confirming a battery swelling phenomenon includes steps of (a) designing an index for confirming a battery swelling phenomenon of a secondary battery, (b) disposing the index for confirming the battery swelling phenomenon of the secondary battery on a surface of the secondary battery, and (c) confirming the battery swelling phenomenon by confirming a change of the index.

### CROSS-REFERENCE TO RELATED APPLICATIONS

This present application claims priority to and the benefit under 35 U.S.C. § 119 (a)-(d) of Korean Patent Application No. 10-2024-0112208, filed on Aug. 21, 2024, in the Korean Intellectual Property Office, the entire disclosure of which is incorporated herein by reference.

### FIELD

The present disclosure relates to a method of confirming a battery swelling phenomenon, and more particularly, to a method of confirming a battery swelling phenomenon by using a fiducial marker or product labeling.

### BACKGROUND

Recently, the battery tends to have a separation type in which the battery is detachable not the existing integrated type (i.e., a type in which the battery cannot be separated from a mobile phone) in line with the EU's eco-friendly basis.

A consumer may replace the battery of a mobile phone by himself or herself by dismantling the mobile phone when the lifespan of the battery of the mobile phone is reduced or the consumer has intention of replacing the battery. A consumer who has a difficulty in dismantling the battery from a device by himself or herself will request the replacement of the battery from a service center or an expert.

As the battery becomes detachable as described herein, the actual condition of the battery, which cannot be known conventionally, can be confirmed as the battery is exposed to the outside.

When battery swelling occurs, the swelling of the battery can be sufficiently confirmed even to the naked eye because the battery is greatly swollen. However, there is a problem in that it is difficult to determine how much progress has been made in the battery swelling or how dangerous the battery is.

### SUMMARY

Embodiments provide a method of confirming whether a battery swelling phenomenon, that is, pre-explosion symptoms of a secondary battery, has occurred from the outside by using a fiducial marker or product labeling having a determined length.

However, objects of the present disclosure are not limited to the aforementioned object, and other objects not described herein may be evidently understood by those skilled in the art from the following description.

Embodiments of the present disclosure relate to a method of confirming a battery swelling phenomenon, and more particularly, to a method of confirming a battery swelling phenomenon by using a fiducial marker or product labeling.

A method of confirming a battery swelling phenomenon according to embodiments of the present disclosure includes steps of (a) designing an index for confirming a battery swelling phenomenon of a secondary battery, (b) disposing the index for confirming the battery swelling phenomenon of the secondary battery on a surface of the secondary battery, and (c) confirming the battery swelling phenomenon by confirming a change of the index.

Step (a) includes designing the index as a fiducial marker having a preset length.

Step (a) includes designing a fiducial marker having a rectangular bar shape.

Step (a) includes designing the index as a fiducial marker having a cross shape.

Step (a) includes designing the index corresponding to product labeling.

Step (a) further includes designing a preset part of a logo included in the product labeling as the index.

Step (a) further includes determining the preset part by using text of PAD artwork.

Step (b) includes disposing the index in a preset area by considering the deformation of appearance of the secondary battery when the battery swelling phenomenon occurs.

Step (b) includes disposing the index in a preset area among edge areas of the secondary battery.

Step (c) includes confirming the battery swelling phenomenon by matching a change of the index with a danger level by considering a divided item for each of a plurality of danger levels according to the swelling of the secondary battery.

Step (c) further includes determining a degree of danger by dividing the degree of danger into division items for each danger level, including “normal” from a designed length of the index to a range of a first preset multiple, “caution” from the designed length of the index to a range of a second preset multiple, “warning” from the designed length of the index to a range of a third preset multiple, and “danger” from the designed length of the index to a range of a fourth preset multiple.

A system for confirming a battery swelling phenomenon according to embodiments of the present disclosure includes memory in which a program that confirms a battery swelling phenomenon by using an index disposed on a surface of a battery is stored and a processor configured to execute the program. The processor outputs the results of confirmation of the battery swelling phenomenon for each of a plurality of danger levels by considering a ratio of change of the index.

The index is disposed on the surface of the battery as a fiducial marker having a preset length.

The index is disposed on the surface of the battery as product labeling including a part having a preset length.

The processor confirms the battery swelling phenomenon by matching the ratio of change of the index by considering a division item for each danger level according to a welling of the battery.

A battery device to confirm the swelling of a battery according to embodiments of the present disclosure includes a fiducial marker disposed on a surface of the battery and having a shape changed depending on a battery swelling phenomenon.

The fiducial marker is formed in a rectangular bar shape.

The fiducial marker is formed in a cross shape.

The fiducial marker is formed in a form of text of product labeling.

The fiducial marker is disposed in a preset area by considering a deformation of appearance of the battery according to the battery swelling phenomenon.

According to embodiments of the present disclosure, if the fiducial marker is used, it is possible to solve a problem related to a print issue (e.g., print quality, a free space, or visual distinction) which occurs when complicated and various patterns in a conventional technology are used and a problem in that it is difficult to exactly confirm the deformation of a battery and to easily confirm a degree of a change in the battery swelling phenomenon when the battery swelling phenomenon occurs by indicating a simple mark having a clear length in the battery.

According to embodiments of the present disclosure, if product labeling is used, an additional pattern is unnecessary and a cost can be reduced.

According to embodiments of the present disclosure, there are advantages in that the present disclosure may be applied to all of secondary batteries in which a battery swelling phenomenon occurs, in addition to the SUS CAN type, and has great expandability because the present disclosure can be applied to a wide range regardless of a shape of a battery and an overall structure of a device.

Effects of the present disclosure are not limited to the aforementioned effects, and the other effects not described herein may be evidently understood by those skilled in the art.

### BRIEF DESCRIPTION OF THE DRAWINGS

The following drawings illustrate example embodiments of the present disclosure, and further describe example aspects of the present disclosure together with the detailed description of the present disclosure. Thus, the present disclosure should not be construed as being limited to the drawings:

FIG. 1 schematically illustrates an electrode assembly of a secondary battery;

FIG. 2 schematically illustrates a configuration of a pouch-type secondary battery;

FIG. 3 illustrates a schematic external appearance configuration of a prismatic secondary battery;

FIG. 4 is a cross-sectional view of a cylindrical secondary battery;

FIGS. 5 and 6 illustrate a battery cell in which a fiducial marker is disposed according to embodiments of the present disclosure.

FIGS. 7 and 8 illustrate product labeling that is disposed to confirm a battery swelling phenomenon according to embodiments of the present disclosure.

FIG. 9 illustrates a method of confirming a battery swelling phenomenon according to embodiments of the present disclosure.

FIG. 10 illustrates a battery cell disposed with conductors according to embodiments of the present disclosure;

FIGS. 11A-11D illustrate a front view and a plan view of a battery cell in a normal state and a swelling state according to embodiments of the present disclosure;

FIG. 12 illustrates a battery cell disposed with conductors according to embodiments of the present disclosure;

FIGS. 13A-13D illustrate a front view and a plan view of a battery cell in a normal state and a swelling state according to embodiments of the present disclosure;

FIGS. 14A-14B illustrate a battery cell disposed with conductors according to further embodiments of the present disclosure;

FIGS. 15A-15B illustrate a capacitance change amount measurement unit according to embodiments of the present disclosure;

FIGS. 16A-16B illustrate a connection of a capacitance change amount measurement unit according to embodiments of the present disclosure;

FIG. 17 illustrates a resonator circuit and a gain adjustment unit that sense a frequency change due to a capacitance change and determine whether battery swelling has occurred according to embodiments of the present disclosure;

FIG. 18 illustrates a case including an additional circuit (a frequency sensing unit) according to embodiments of the present disclosure;

FIG. 19 illustrates a method for detecting battery swelling according to embodiments of the present disclosure;

FIG. 20 is a block diagram illustrating a computer system for implementing a method according to an example embodiment of the present disclosure;

FIG. 21 is an example view of a secondary battery module in which secondary batteries manufactured according to examples of the present disclosure are arranged;

FIG. 22 is an example view of a secondary battery pack including the secondary battery module illustrated in FIG. 21; and

FIG. 23 is a conceptual view of a vehicle including the secondary battery pack illustrated in FIG. 22.

### DETAILED DESCRIPTION

Hereinafter, example embodiments of the present disclosure will be described, in detail, with reference to the accompanying drawings. The terms or words used in the present specification and claims are not to be limitedly interpreted based on their general or ordinary meaning, and should be interpreted as meanings and concepts that are consistent with the technical idea of the present disclosure on the basis of the principle that an inventor can be their own lexicographer to appropriately define concepts of terms to describe their disclosure in the best way.

The example embodiments described in this specification and the configurations shown in the drawings are only some example embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges is within the scope of this disclosure.

References to two compared elements, features, etc. As being “the same” may mean that they are “substantially the same.” Thus, the phrase “substantially the same” may include a circumstance having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

The terminology used herein is for the purpose of describing example embodiments of the present disclosure and is not intended to limit the present disclosure.

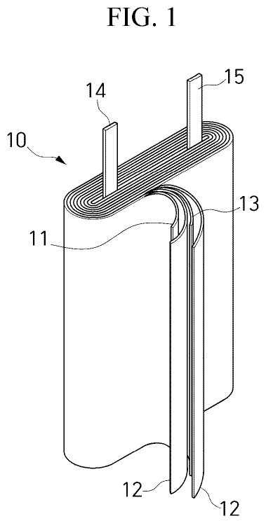

FIG. 1 schematically illustrates an electrode assembly built in a case of a secondary battery.

An electrode assembly 10 may be formed by winding or stacking a stack of a first electrode plate 11, a separator 12, and a second electrode plate 13, which are formed as thin plates or films. When the electrode assembly 10 wound stack, a winding axis may be parallel to the longitudinal direction (e.g., the y direction) of the case 59. In other example embodiments, the electrode assembly 10 may be a stack type rather than a winding type, and the shape of the electrode assembly 10 is not limited in the examples of the present disclosure. In addition, the electrode assembly 10 may be or include a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the examples of the present disclosure. The first electrode plate 11 of the electrode assembly may act as a negative electrode, and the second electrode plate 13 may act as a positive electrode. In examples, the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal (not shown). In some example embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than, e.g., farther than or beyond, the separator 12 without being separately cut.

The second electrode plate 13 may be formed by applying a second electrode active material, such as a transition metal oxide, on a second electrode current collector formed of or including a metal foil, such as aluminum or an aluminum alloy. The second electrode plate 13 may include a second electrode tab 15 (e.g., a second uncoated portion) that is or includes a region to which the second electrode active material is not applied. The second electrode tab 15 may be connected to an external second terminal (not shown). In some example embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more farther than or beyond, the separator 12 without being separately cut.

In some example embodiments, the first electrode tab 14 may be located on the left side of the electrode assembly 10, and the second electrode tab 15 may be located on the right side of the electrode assembly 10. In other example embodiments, the first electrode tab 14 and the second electrode tab 15 may be located on one side of the electrode assembly 10 in the same direction.

Here, for convenience of description, the left and right sides are defined according to the electrode assembly 10 as oriented in FIG. 1, and the positions thereof may change when the secondary battery is rotated left and right or up and down.

The separator 12 hinders or substantially prevents a short-circuit between the first electrode 11 and the second electrode 13 while allowing movement of lithium ions therebetween. The separator 12 may be made of or include, for example, a polyethylene film, a polypropylene film, a polyethylene-polypropylene film, etc.

In some example embodiments, the electrode assembly 10 may be accommodated in the case (not shown) along with an electrolyte. In the circumstance of a pouch-type secondary battery, an electrode assembly 10 may be accommodated in a pouch made of or including flexible material in the form illustrated in FIG. 1. In the circumstance of a prismatic secondary battery, an electrode assembly 10 may be accommodated in a prismatic metal casing in the form illustrated in FIG. 1.

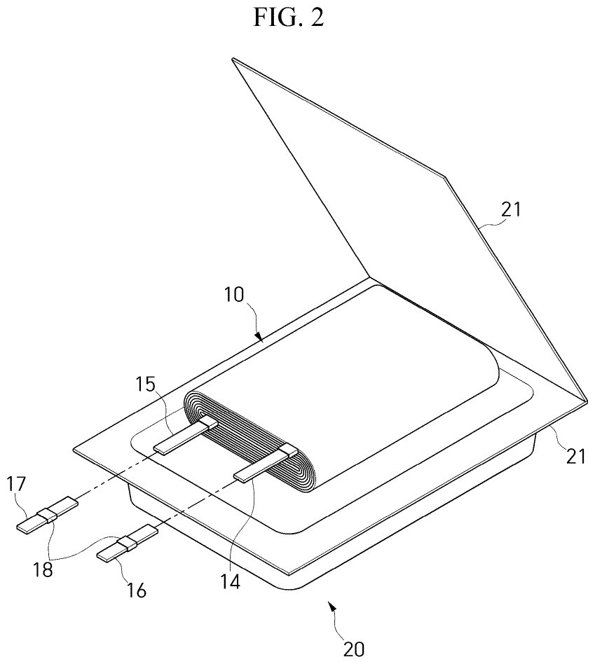

FIG. 2 schematically illustrates the pouch-type secondary battery.

The pouch-type secondary battery includes an electrode assembly 10 and a pouch 20 that accommodates or contains the electrode assembly 10 therein.

The electrode assembly 10 may be the same as the electrode assembly 10 illustrated in FIG. 1. The first electrode tab 14 and the second electrode tab 15 of the electrode assembly 10 may be electrically connected to respective external first and second terminal leads 16 and 17 by, e.g., welding or other attaching method that preserves conductivity therebetween. At least a portion of each of the first terminal lead 16 and the second terminal lead 17 may be attached or covered with a tab film 18 for insulation from the pouch 20.

The pouch 20 may be sealed by having sealing parts 21 at the edges thereof come into contact with each other while accommodating or containing the electrode assembly 10 therein, in which circumstance the sealing may be achieved with the tab film 18 interposed between the sealing parts 21. The sealing parts 21 of the pouch 20 may be made of or include a thermal fusion material that generally has weak adhesion to metal. Thus, it may be fused to the pouch 20 by interposing the thin tab film 18 between the sealing parts 21.

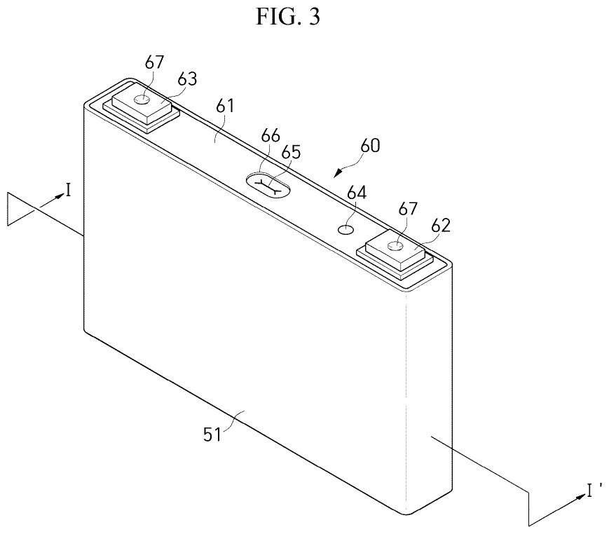

FIG. 3 illustrates a schematic external appearance configuration of a prismatic secondary battery.

A prismatic case 59 defines an overall appearance of the prismatic secondary battery, and may be made of or include a conductive metal, such as aluminum, aluminum alloy, or nickel-plated steel. In addition, the case 59 may provide a space for accommodating or containing the electrode assembly 10 therein.

A cap assembly 60 may include a cap plate 61 that covers an opening of the case 59, and the case 59 and the cap plate 61 may be made of or include a conductive material. A first terminal 63 and a second terminal 62 may be electrically connected to the first electrode tab 14 and the second electrode tab 15 of the electrode assembly 10 illustrated in FIGS. 1 and 2 inside the case 59, and may be installed to protrude outward through the cap plate 61.

The cap plate 61 may be equipped with or include an electrolyte injection port 64 configured to install a sealing plug therein, and a vent 66 formed that includes a notch 65 may be installed. The vent 66 is configured to discharge any gas generated inside the secondary battery.

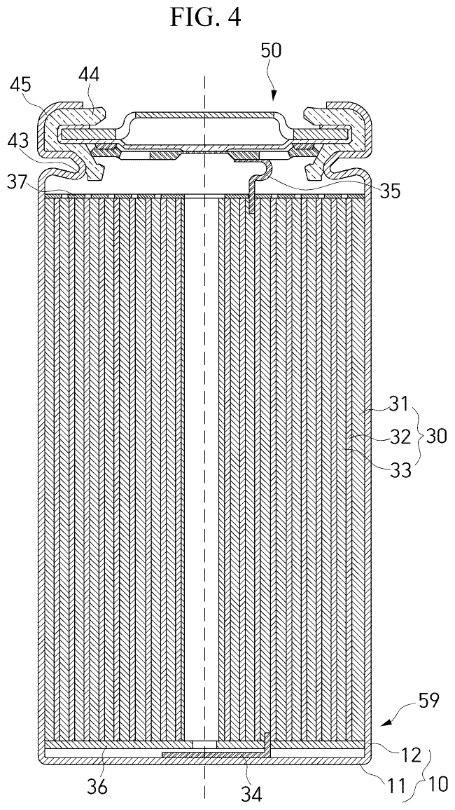

FIG. 4 is a cross-sectional view of a cylindrical secondary battery.

The cylindrical secondary battery includes an electrode assembly 30, a case accommodating the electrode assembly 30 and an electrolyte therein, a cap assembly 50 coupled to an opening of the case to seal the case, and an insulating plate 37 located between the electrode assembly 30 and the cap assembly 50 inside the case.

The electrode assembly 30 may include a separator 32 between a first electrode 33 and a second electrode 31, and the electrode assembly 30 may be wound in a jelly-roll form.

The first electrode 33 may include a first substrate and a first active material layer located on the first substrate. A first lead tab 35 may extend outward from a first uncoated portion of the first substrate where the first active material layer is not located, and may be electrically connected to the cap assembly 50.

The second electrode 31 may include a second substrate and a second active material layer located on the second substrate. A second lead tab 34 may extend outward from a second uncoated portion of the second substrate where the second active material layer is not located, and may be electrically connected to the case. The first lead tab 35 and the second lead tab 34 may extend in opposite directions with respect to each other.

The first electrode 33 may constitute a positive electrode. In this circumstance, the first substrate may be composed of or include, for example, aluminum foil, and the first active material layer may include, for example, a transition metal oxide. The second electrode 31 may constitute a negative electrode. In this case, the second substrate may be composed of or include, for example, copper foil or nickel foil, and the second active material layer may include, for example, graphite.

The separator 32 may reduce or prevent a short-circuit between the first electrode 33 and the second electrode 31 while allowing movement of lithium ions therebetween. The separator 32 may be made of or include, for example, at least one of a polyethylene film, a polypropylene film, a polyethylene-polypropylene film, etc.

The case accommodates or contains the electrode assembly 30 and the electrolyte, and substantially forms the external appearance of the secondary battery together with the cap assembly 50. The case may have a substantially cylindrical body portion 42, and a bottom portion 41 connected to one side of the body portion 42. A beading part 43 deformed inwardly may be formed in the body portion 42, and a crimping part 45 bent inwardly may be formed at an open end of the body portion 42.

The beading part 43 may reduce or prevent movement of the electrode assembly 30 inside the case, and may facilitate seating of a gasket 44 and the cap assembly 50. A crimping part 45 may firmly fix the cap assembly 50 by pressing the edge of the cap assembly 50 against the gasket 44. The case may be formed of or include iron plated with nickel, for example.

The cap assembly 50 may be fixed to the inside of the crimping part 45 through the gasket 44 to seal the case. The cap assembly 50 may include a cap up, a safety vent, a cap down, an insulating member, and a subplate, but is not limited to this example and may be variously modified.

The cap up may be located at the very top of the cap assembly 50. The cap up may include a terminal portion that protrudes convexly upward and is connected to an external circuit, and an outlet for discharging gas may be located around the terminal portion.

The safety vent may be located below the cap up. The safety vent may include a protrusion that protrudes convexly downward and is connected to the subplate, and at least one notch located around the protrusion.

When gas is generated due to overcharging or abnormal operation of the secondary battery, the protrusion may be deformed upward by pressure and may separate from the subplate, while the safety vent may be cut along the notch. The cut safety vent may hinder or prevent the secondary battery from exploding by discharging gas to the outside.

The cap down may be located below the safety vent. The cap down may be formed with a first opening for exposing the protrusion of the safety vent and a second opening for discharging gas. The insulating member may be located between the safety vent and the cap down to insulate the safety vent and the cap down.

The subplate may be located below the cap down. The subplate may be fixed to a lower surface of the cap down to block the first opening of the cap down, and the protrusion of the safety vent may be fixed to the subplate. The first lead tab 35 pulled out from the electrode assembly 30 may be fixed to the subplate. Accordingly, the cap up, the safety vent, the cap down, and the subplate may be electrically connected to the first electrode 33 of the electrode assembly 30.

The insulating plate 37 may be located below the beading portion 43 to be in contact with the electrode assembly 30, and may be provided with a tab opening for pulling out the first lead tab 35. The cap assembly 50, which is electrically connected to the first electrode 33 by the first lead tab 35, may face the electrode assembly 30 with the insulating plate 37 interposed therebetween, and may maintain an insulated state from the electrode assembly 30 by the insulating plate 37. On the other hand, another insulating plate 36 may be included for insulation between the electrode assembly 30 and the bottom portion 41 of the case.

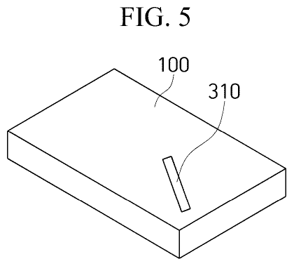

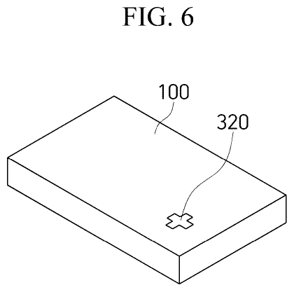

FIGS. 5 and 6 illustrate a battery cell in which a fiducial marker is disposed according to embodiments of the present disclosure.

The fiducial marker may be a mark that is basically formed at four corners of a substrate in order to confirm a machine operation location upon surface mounting by using SMT equipment, and may be interpreted as a “reference index” or a “recognition code”.

A fiducial marker 310, 320 may be disposed on a surface of a battery cell 100. As illustrated in FIGS. 5 and 6, the fiducial marker having a bar shape or a cross shape may be disposed at a corner on one side of the surface of the battery cell 100 so that a swelling change can be recognized. The shape and arrangement location of the fiducial marker may be variously changed.

For example, when the fiducial marker 320 having a cross shape and a determined length (e.g., 0.5 cm) is printed on the battery cell 100, the length of the cross shape may be changed when the swelling of a battery occurs. In this case, how long has the length changed may be confirmed by calculating the ratio of the changed length to a determined length.

When swelling occurs in the battery cell 100, an expanded shape of the battery cell may be almost similar and may not have a great deviation because curvature of the expanded shape is almost similar. Accordingly, the ratio of a deformed length of the fiducial marker may be different depending on how swelling occurs. It is possible to differently determine a degree of danger of battery swelling by dividing a preset step based on the ratio of change of the deformed length.

For example, when a reference length is 0.5 cm, the degree of danger may be divided into division items for each danger level, including “normal” having a range of 0.5 cm to 0.65 cm, “caution” having a range of more than 0.65 cm to 0.80 cm or less, “warning” having a range of more than 0.80 cm to 1.00 cm, and “danger” having a range of more than 1.00 cm. The degree of danger may be determined by matching the degree of danger with the ratio of a specific swelling step.

It is preferred that the fiducial marker is disposed in a preset area at the four corners of the battery cell, which have the greatest curve when a battery swelling phenomenon occurs. If safety, a QR code, or a logo is disposed in a corresponding area, the fiducial marker may not need to be essentially disposed in the corresponding area, and the curve of the battery cell may be different depending on the location at which the fiducial marker is disposed. The degree of danger and the ratio of change may be matched depending on the curve of the battery cell.

According to embodiments of the present disclosure, the shape of the fiducial marker is not limited to a specific shape as described herein and is also not limited to a specific direction.

Referring to FIG. 5, if the fiducial marker 310 is diagonally disposed, the greatest curve may be formed when the swelling of the battery cell occurs. FIG. 5 illustrates the fiducial marker 310 that has been diagonally disposed.

In FIG. 5, the fiducial marker may be disposed as a single elongated bar either horizontally or vertically, and not only straight lines but also curved fiducial markers can be used. By checking whether the curvature of the fiducial marker changes, it is also possible to verify the battery swelling phenomenon.

When the fiducial marker having a preset length is printed on the battery cell 100 as described herein, the length of the fiducial marker may be differently changed depending on whether a battery swelling phenomenon occurs. A change in the length may be confirmed by calculating the ratio of the deformed length to a reference length.

According to embodiments of the present disclosure, a consumer, an inspector, or an inspection machine may confirm how much the fixed length of the fiducial marker has changed when a battery swelling phenomenon occurs. For example, the battery swelling phenomenon may be confirmed by a length change or curvature change of the fiducial marker or using a tapeline.

After a mobile phone having a detachable battery is dismantled, it is possible to confirm how much the length of the fiducial marker has changed with respect to a specific length by confirming the length of the fiducial marker disposed in a preset area of the battery.

For example, when the length of the fiducial marker is changed from 0.5 cm to 0.7 cm, a manufacturing company may suggest a degree of danger for the length through a matching table. A consumer may confirm a battery condition and the degree of danger by confirming the matching table.

The fiducial marker may be disposed in the same way as a method of marking product information on a battery pack, such as printing, marking, or etching.

According to embodiments of the present disclosure, expansion that occurs upon common charging/discharging may be determined to be in a “normal” state. In this case, matching data may be different for each battery.

If the expansion is not in the normal state, a value greater than a value in the normal state may be provided to a consumer for each step. According to embodiments of the present disclosure, it is possible to confirm a battery swelling phenomenon in efficient, very rapid, and simple ways because a degree of danger can be immediately determined by using only a tapeline as soon as the swelling of the battery is discovered.

A manufacturing company may post a matching table on an Internet homepage which can be easily accessed by consumers or may add battery directions. The matching table may be written according to various criteria because the matching table has a different size and different tendency for each battery. It is possible to easily expand the range of application of the matching table because the matching table can be provided to consumers for each application.

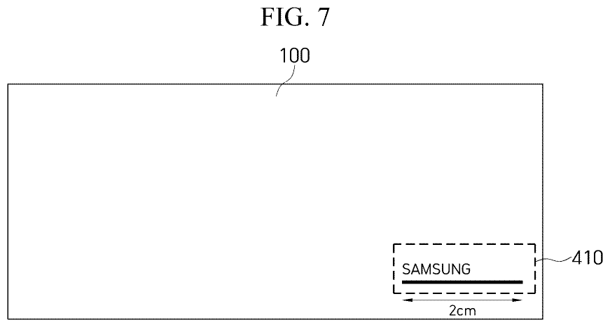

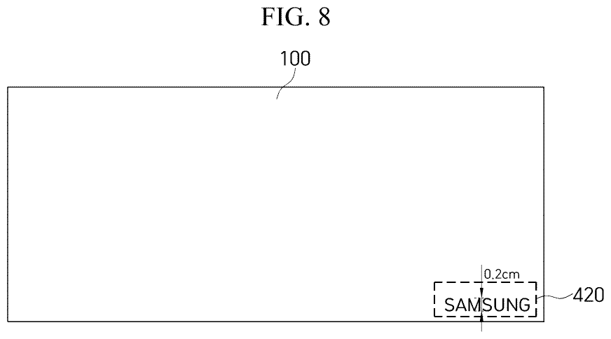

FIGS. 7 and 8 illustrate product labeling that is disposed to confirm a battery swelling phenomenon according to embodiments of the present disclosure.

Product labeling may be disposed in a preset area 410, 420 on a surface of the battery cell 100 so that a swelling change can be recognized. A shape of the product labeling and a location at which the product labeling is disposed may be variously changed.

Referring to FIG. 7, a SAMSUNG logo and an underlined line (e.g., a specific length of 2 cm) below the SAMSUNG logo may be disposed. A manufacturing company may suggest a table for a degree of danger for each change ratio on the basis of a specific length of the underlined line.

Referring to FIG. 8, the height of a right part in a specific part (e.g., an alphabetical letter “M”) of the SAMSUNG logo may be suggested as a specific length (e.g., 0.2 cm). It is possible to use text of PAD artwork.

Furthermore, according to embodiments of the present disclosure, a shape of the product labeling is not limited as long as the product labeling may be indicated on a surface of a battery cell or pack.

In a table according to embodiments of the present disclosure, for example, when a reference length is 2 cm, a degree of danger may be divided into division items for each danger level, including “normal” having a range of 2.0 cm to 2.2 cm, “caution” having a range of more than 2.2 cm to 2.4 cm less, “warning” having a range of more than 2.4 cm to 2.6 cm, and “danger” having a range of more than 2.6 cm. The degree of danger may be determined by matching the degree of danger with the ratio of a specific swelling step. The battery cell 100 capable of confirming the swelling according to embodiments of the present disclosure includes a fiducial marker that is disposed on a surface of the battery cell and that has a shape deformed depending on a battery swelling phenomenon.

The fiducial marker may be formed of the fiducial marker 310 having a rectangular bar shape or the fiducial marker 320 having a cross shape or may be formed in the form of text of product labeling. If the fiducial marker is formed in the form of text of product labeling, the fiducial marker may be formed as a preset part (e.g., text of PAD artwork) of a logo that is included in the product labeling. The fiducial marker may be disposed in the preset area 410, 420 by considering the deformation of appearance of the battery according to a battery swelling phenomenon.

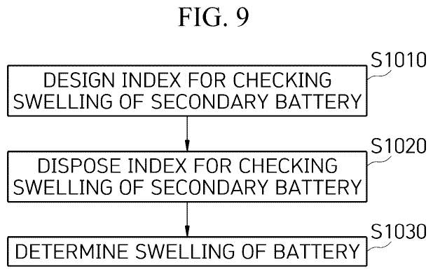

FIG. 9 illustrates a method of confirming a battery swelling phenomenon according to embodiments of the present disclosure.

The method of confirming a battery swelling phenomenon according to embodiments of the present disclosure may include step S1010 of designing an index for confirming the swelling of a secondary battery, step S1020 of disposing, in the secondary battery, the index for confirming the swelling of the secondary battery, and step S1030 of determining whether the swelling of the secondary battery has occurred.

In step S1010, a fiducial marker may be designed as the index for confirming the swelling of the secondary battery. The fiducial marker may be designed to have a bar shape or a cross shape. The design of a shape of the fiducial marker and a location at which the fiducial marker is disposed may be variously changed. The fiducial marker may be disposed as a single elongated line either horizontally or vertically, and not only straight lines but also curved fiducial markers can be used. By checking how much the curvature changes, it is also possible to confirm the battery swelling phenomenon.

In step S1020, the fiducial marker may be disposed on a surface of the secondary battery. It is preferred that the fiducial marker is disposed in a preset area at the four corners of the secondary battery. That is, it is preferred that the fiducial marker is disposed in a preset area at the four corners of the secondary battery, have the greatest curve when a battery swelling phenomenon occurs. However, if safety, a QR code, or a logo is disposed in a corresponding area, the fiducial marker may be disposed in another area. However, the curve of the secondary battery may be different depending on the location at which the fiducial marker is disposed. The danger level and the ratio of change may be matched depending on the curve of the secondary battery.

In step S1030, a battery swelling phenomenon may be confirmed for each step by confirming a change in the length of the fiducial marker to the existing length. For example, when a reference length is 0.5 cm, the degree of danger may be divided into division items for each danger level, including “normal” having a range of 0.5 cm to 0.65 cm, “caution” having a range of more than 0.65 cm to 0.80 cm or less, “warning” having a range of more than 0.80 cm to 1.00 cm, and “danger” having a range of more than 1.00 cm. The degree of danger may be determined by matching the degree of danger with the ratio of a specific swelling step.

In step S1030, a consumer, an inspector, or an inspection machine may confirm how much the fixed length of the fiducial marker has changed when a battery swelling phenomenon occurs. For example, the battery swelling phenomenon may be confirmed by a length change or curvature change of the fiducial marker or using a tapeline.

As another example, in step S1010, product labeling may be designed as an index for confirming the swelling of the secondary battery.

In step S1020, a preset logo and an underlined line (designed to have a specific length) below the preset logo may be disposed as the product labeling, or a logo including a part that is designed to have a specific length may be disposed as the product labeling. That is, text of PAD artwork may be used. A shape of the product labeling is not limited to as long as the product labeling includes contents which may be indicated on a surface of a battery cell or pack.

In step S1030, a battery swelling phenomenon may be confirmed by confirming a change in the length of a straight line or a specific part (e.g., a specific part of as described herein) that is text included in a logo included in the product labeling. In this case, for example, in a table, when a reference length is 2 cm, a degree of danger may be divided into division items for each danger level, including “normal” having a range of 2.0 cm to 2.2 cm, “caution” having a range of more than 2.2 cm to 2.4 cm less, “warning” having a range of more than 2.4 cm to 2.6 cm, and “danger” having a range of more than 2.6 cm. It is possible to confirm a battery swelling phenomenon by dividing a degree of danger based on the table.

Hereinafter, a method for detecting battery swelling based on a capacitance sensing technique according to embodiments of the present disclosure will be described.

In order to prevent secondary battery explosion accidents in advance, the related art has proposed a method for detecting swelling being a sign of battery explosion by using strain sensing.

The related art has proposed a method for detecting strain by attaching a thin-film strain sensor to the outer surface of a pouch based on the observation that a pouch film surrounding a battery is bent and deformation (strain) occurs in the pouch as swelling occurs from inside the battery. Since the thin-film strain sensor is based on metal, has a low gauge ratio of about 2 to 3, and has difficulty in sensitively responding to a small range of strain, a thin-film single crystal silicon-based strain sensor having a much higher gauge ratio than the metal-based strain sensor has been proposed. However, the structure and manufacturing method of the thin-film single crystal silicon-based strain sensor are complicated.

The present disclosure is proposed to solve the herein-mentioned problem, and proposes a method for detecting battery swelling based on capacitance sensing, which has the advantage of being simple in structure, easy to implement, and relatively low in cost by using a material that can have capacitance such as a conductor, so that the present disclosure can be applied in a wide range. The method for detecting battery swelling according to embodiments of the present disclosure can be applied regardless of an overall device structure or a battery shape such as a circular shape, a prismatic shape, and a pouch shape, and thus has the advantage of very high expandability.

According to embodiments of the present disclosure, when a cell operates normally, the surface of the cell is maintained flat. However, when swelling occurs due to an abnormality in the cell, since the distance between two conductors formed on the surface increases and accordingly, the capacitance is changed, the occurrence of the abnormality is determined by measuring the change in capacitance.

The shape of the conductor arranged in a conductor arrangement region can be configured in various shapes and is not limited to a specific shape or length.

Since the conductor can be formed with various materials other than metal and any material that can form capacitance can be applied, the conductor is not limited to a specific material.

Various methods can be applied as a method for measuring capacitance changes. For example, frequency changes due to capacitance changes can be detected in an oscillator circuit. That is, in a capacitor formed with conductors on a cell, when the distance between the conductors is changed due to swelling, frequency changes due to capacitance changes can be detected. This is an example for assisting the understanding of those skilled in the art, and is not limited to specific capacitance sensing.

Dielectrics can be made of various materials, and various materials that are easy to manufacture, such as air, acrylic, glass, and rubber, can all be used. However, when the material is included, since the manufacturing process is complicated and the manufacturing cost increases, other materials are not preferably used additionally if possible.

The shape of the conductor is formed with a metal pattern or the like on a film rather than connected with individual lines, which facilitate manufacturing, and the film other than the metal pattern can serve as a dielectric.

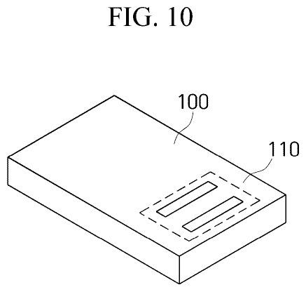

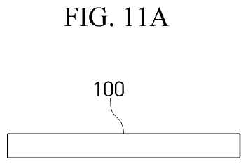

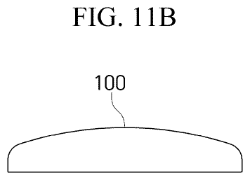

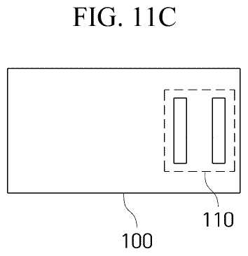

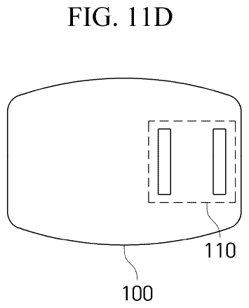

FIG. 10 illustrates a battery cell disposed with conductors according to embodiments of the present disclosure, and FIGS. 11A-11D illustrate a front view and a plan view of a battery cell in a normal state and a swelling state according to embodiments of the present disclosure. This a illustration for is simplified describing the arrangement of conductors and may differ from the actual arrangement.

Referring to the front view corresponding to FIG. 11B compared to the normal state corresponding to FIG. 11A, when swelling occurs, bending occurs upward (sideways), and due to this bending, as illustrated in the plan view of FIG. 11D compared to FIG. 11C, the distance between two conductors formed in a first region 110 of a battery cell 100 relatively increases. When the distance between the two conductors increases, since a difference occurs compared to the capacitance in the normal state, whether swelling has occurred can be detected by detecting the difference (capacitance is calculated based on the relative permittivity and the area and distance of the conductive plate and is proportional to the area and inversely proportional to the distance).

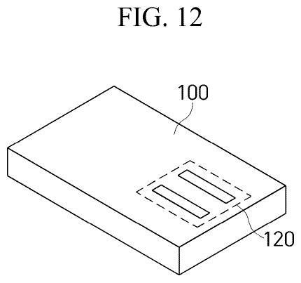

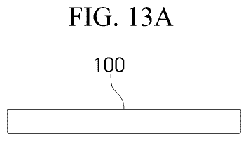

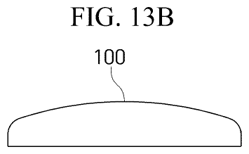

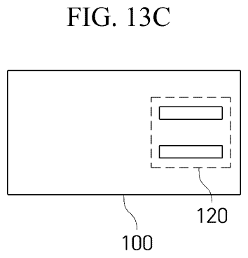

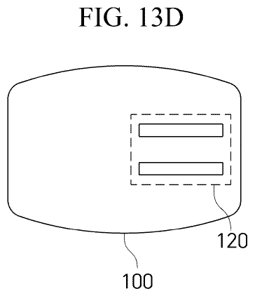

FIG. 12 illustrates a battery cell disposed with conductors according to embodiments of the present disclosure, and FIGS. 13A-13D illustrate a front view and a plan view of a battery cell in a normal state and a swelling state according to embodiments of the present disclosure. As described herein, this is a simplified illustration for describing the arrangement of conductors and may differ from the actual arrangement.

Referring to the front view corresponding to FIG. 13B compared to the normal state corresponding to FIG. 13A, when swelling occurs, bending occurs upward (sideways), and due to this bending, as illustrated in the plan view of FIG. 13D compared to FIG. 13C, the distance between two conductors formed in a second region 120 of a battery cell 100 increases. Since the length of the conductor increases and a difference occurs compared to the capacitance in the normal state, whether swelling has occurred can be detected by detecting the difference.

In the embodiments illustrated in FIGS. 10 and 11A-11D, the distance between the two conductors arranged in the first region 110 increases and the capacitance value is gradually decreased, while in the embodiments illustrated in FIGS. 12 and 13A-13D, an area of the two conductors arranged in the second region 120 increases and the capacitance value is gradually increased. That is, although the structures are similar, completely opposite results are derived depending on the direction of arrangement (horizontal/vertical).

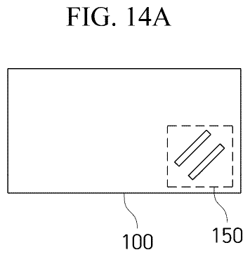

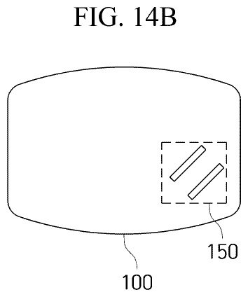

FIGS. 14A-14B illustrate a battery cell disposed with conductors according to further embodiments of the present disclosure. FIG. 14A is a front view illustrating a battery cell disposed with conductors according to further embodiments of the present disclosure, and FIG. 14B is a plan view illustrating the battery cell disposed with the conductors according to further embodiments of the present disclosure. Referring to FIGS. 14A-14B, when swelling actually occurs, the bending of a battery is changed the most at the edges of four sides thereof. Accordingly, when the conductors are placed in a corresponding region 150, the effect related to the capacitance change amount measurement is the greatest.

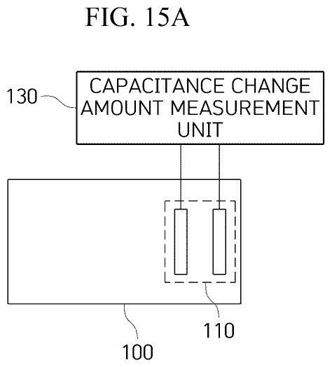

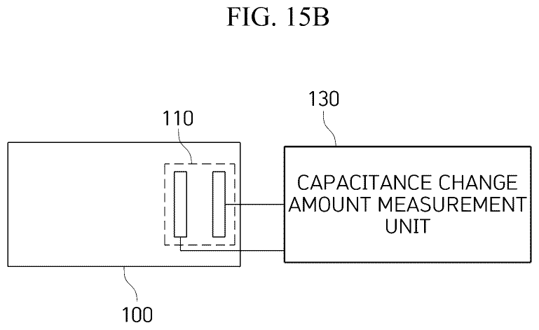

FIGS. 15A-15B illustrates a capacitance change amount measurement unit according to embodiments of the present disclosure.

As illustrated in FIGS. 15A-15B, conductors placed in a first 110 (FIGS. 15A-15B illustrate the conductor arrangement according to the embodiments described herein) are connected to a capacitance change amount measurement unit 130, and the capacitance change amount measurement unit 130 measures a capacitance change amount that changes according to a change in distance (according to a change in area in the circumstance of the conductor arrangement according to the embodiments described in FIGS. 12 and 13A-13D). In such a case, a method of connecting to the capacitance change amount measurement unit 130 may use various methods, and is not limited to the location and can vary on the application. According to embodiments of the present disclosure, the connection between the conductor and the capacitance change amount measurement unit 130 is an electrical connection, is sufficient if it can confirm a capacitance change, and is not limited to a single connection method.

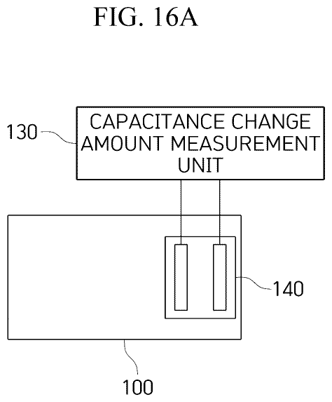

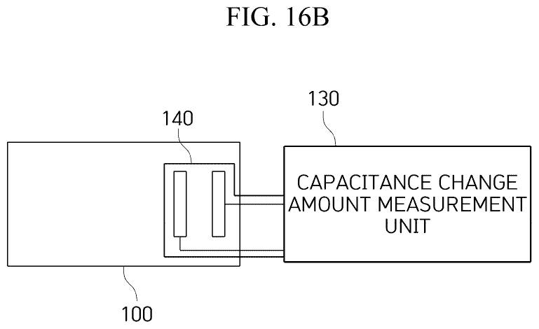

FIGS. 16A-16B illustrate a connection of a capacitance change amount measurement unit according to embodiments of the present disclosure.

A film 140 may be used to include conductors, place the conductors therebetween, or place the conductors thereon, and is not limited to a specific shape, pattern, length, and the like.

When the film 140 has a shape that wraps the conductors, the film between the conductors serves as a dielectric. In such a case, since the dielectric contributes to the formation of capacitance, a capacitance change amount may be different accordingly.

Accordingly, various types of films may be used to adjust a capacitance change amount depending on the application, and the film is not limited to a specific single type.

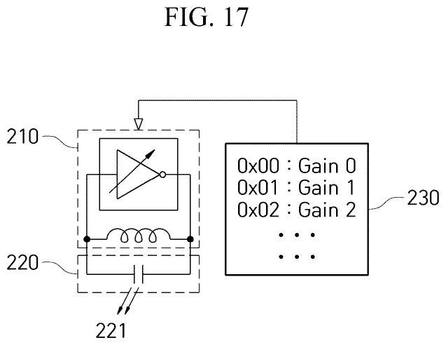

FIG. 17 illustrates a resonator circuit and a gain adjustment unit that sense a frequency change due to a capacitance change and determine whether battery swelling has occurred according to embodiments of the present disclosure.

FIG. 17 illustrates a circuit of a variable resonator, but according to embodiments of the present disclosure, an LC resonator may be formed by a resonator circuit unit including an integrated circuit or the like, a capacitor implementation unit, and a conductor included in the capacitor implementation unit. That is, a frequency is determined by L and C, and resonance is maintained by an amplifier (Amp.). (Amp.). As described herein, the amplifier and the inductor can be implemented inside an integrated circuit (IC), and the capacitor implementation unit can be implemented outside the IC and attached to a battery according to embodiments of the present disclosure.

The frequency of the resonator is determined by L and C as in Equation 1 herein.

$$f = \frac{1}{2 π \sqrt{LC}} \qquad Equation 1$$

L is implemented inside the IC and has a fixed value, and C is determined by two conductors attached to the battery. In a normal state where no swelling has occurred, a capacitance value is fixed and a constant frequency is determined, but as swelling occurs and the distance between the conductors increases, the capacitance value decreases and the frequency increases. This deviation is used to determine whether the battery swelling has occurred. The circuit described herein is an example of an LC resonator using a capacitor, and is not limited to the circuit.

In the resonator circuit, the amplifier plays a role in maintaining oscillation. Assuming ideal inductor L and capacitor C, incoming energy is exchanged and resonance is maintained, but actually, since there is a resistance component, the resonance is not maintained, the magnitude of a waveform gradually decreases, and the resonance disappears. The amplifier is required to maintain oscillation, and is generally expressed by a negative resistor and is expressed by an opposite component-R of an actual resistance component R.

When a capacitor is implemented through a conductor, a resistance component varies depending on the application. That is, when the resistance is larger than the expected design, since the negative resistance component f an amplifier does not offset a large resistance component, the resonance may not be maintained.

Referring to FIG. 12, in order to solve such a problem, an adaptive amplifier can be applied instead of a fixed amplifier and includes an adaptive resonator circuit unit 210, a capacitor implementation unit 220, and a conductor 221 included in the capacitor implementation unit 220, and a gain adjustment unit 230.

According to embodiments of the present disclosure, the gain adjustment unit 230 is provided to be able to adjust the gain Gain of the amplifier in relation to the configuration of the adaptive amplifier, and a corresponding gain can be provided for each application when actually applied.

After an additional circuit is added to determine whether a resonator is operating, when it is determined that the resonator is not operating, it is possible to recognize that the resonator is not operating and automatically adjust the gain and also to control the resonator to operate.

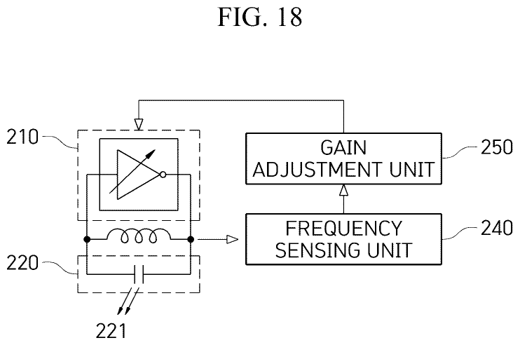

FIG. 18 illustrates case including an additional circuit (a frequency sensing unit) according to embodiments of the present disclosure.

Referring to FIG. 18, the gain can be adjusted by adjusting a control bit corresponding to each application, and the amplifier includes a frequency sensing unit 240 being an additional circuit for determining whether the resonator is operating, and automatically adjusts the gain through a gain adjustment unit 250.

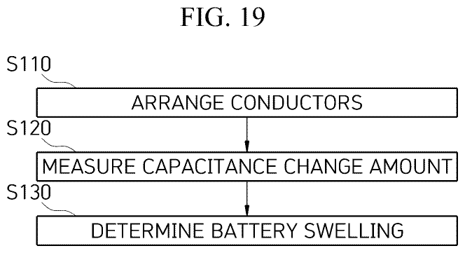

FIG. 19 illustrates a method for detecting battery swelling according to embodiments of the present disclosure.

The method for detecting battery swelling according to embodiments of the present disclosure includes step S110 of arranging conductors in a preset region in order to detect battery swelling, step S120 of measuring a capacitance change amount according to a change in the conductors, and step S130 of determining whether the battery swelling has occurred using a result of measuring the capacitance change amount.

In step S110, the conductors are arranged in a first region, and in step S120, the capacitance change amount according to an increase in the distance between the conductors arranged in the first region is measured.

In step S110, the conductors are arranged in a second region, and in step S120, the capacitance change amount according to an increase in an area of the conductors arranged in the second region is measured.

In step S110, the conductors are arranged in the preset region being an edge region of a battery cell in consideration of the battery swelling.

In step S110, a film including the conductors is arranged in the preset region.

The type of film is determined in order to adjust the capacitance change amount according to the application.

The method for detecting battery swelling according to embodiments of the present disclosure may further include a step of sensing whether a resonator connected to a capacitance implementation unit formed of the conductors is operating, and in such a case, the gain of a variable amplifier is adjusted in consideration of a result of sensing whether the resonator is operating.

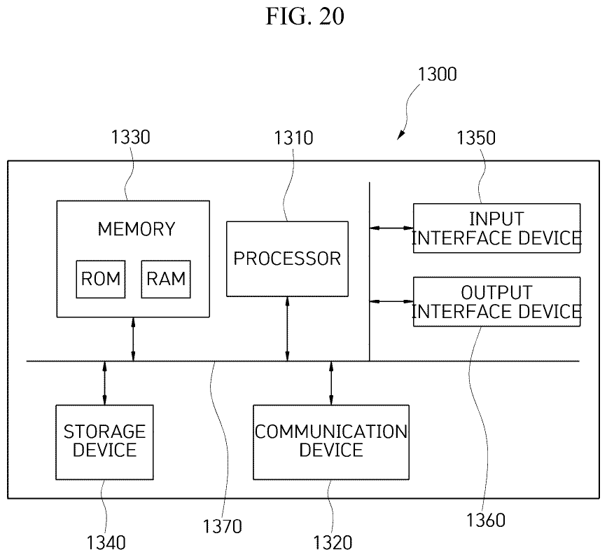

FIG. 20 is a block diagram illustrating a computer system for implementing a method according to an example embodiment of the present disclosure.

Referring to FIG. 20, the computer system 1300 may include at least one of a processor 1310, a memory 1330, an input interface device 1350, an output interface device 1360, and a storage device 1340 communicating with one another through a bus 1370. The computer system 1300 may also include a communication device 1320 coupled to a network. The processor 1310 may be or include a central processing unit (CPU) or a semiconductor device that executes instructions stored in the memory 1330 or in the storage device 1340. The memory 1330 and the storage device 1340 may include various types of volatile or nonvolatile storage media. For example, the memory may include a read-only memory (ROM) and a random access memory (RAM). In example embodiments of the present disclosure, the memory may be located inside or outside the processor, and may be connected to the processor through various known means. The memory is or includes various types of volatile or nonvolatile storage media, and for example, may include a read-only memory (ROM) or a random access memory (RAM).

Accordingly, example embodiments of the present disclosure may be implemented as a method implemented in a computer or a non-transitory computer-readable medium storing computer-executable instructions. In an example embodiment, when executed by the processor, computer-readable instructions may perform a method according to at least one aspect of the present disclosure.

The communication device 1320 may transmit or receive wired signals or wireless signals.

Additionally, the method according to an example embodiment of the present disclosure may be implemented in the form of program instructions that can be executed through various computer means and recorded on a computer-readable medium.

The computer-readable medium may include program instructions, data files, data structures, etc., singly or in combination. The program instructions recorded on the computer-readable medium may be specially designed and configured for the example embodiments of the present disclosure, or may be known and usable by those skilled in the art of computer software. Computer-readable recording media may include a hardware device configured to store and perform program instructions. For example, the computer-readable recording media may be or include magnetic media such as hard disks, floppy disks, and magnetic tapes, optical media such as CD-ROMs and DVDs, magneto-optical media such as floptical disks, ROM, RAM, flash memory, etc. The program instructions may include not only machine language codes such as that generated by a compiler, but also high-level language codes that can be executed by a computer through an interpreter, etc.

Hereinafter, any material that may be usable for the secondary battery according to examples of the present disclosure will be described.

As the positive electrode active material, a compound capable of reversibly intercalating/deintercalating lithium (e.g., a lithiated intercalation compound) may be used. For example, at least one of a composite oxide of lithium and a metal such as at least one of cobalt, manganese, nickel, and combinations thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by at least any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0≤d≤2); LiₐNi_{1-b-c}Mn_{b}X_{c}O_{2-α}D_{α} (0.90≤a≤1.8, 0≤b≤0.5, 0≤c≤0.5, 0≤d≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be or include aluminum (Al) but is not limited thereto.

The negative electrode active material may include a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon-based negative electrode active material, which may include, for example, at least crystalline carbon, amorphous carbon, or a combination thereof. Examples of the crystalline carbon may include graphite, such as natural graphite or artificial graphite, and examples of the amorphous carbon may include at least one of soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be or include at least silicon, a silicon-carbon composite, Siox (0<x<2), a Si-based alloy, or a combination thereof.

The silicon-carbon composite may be or include a composite of silicon and amorphous carbon. According to one example embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, at least one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include at least a carbonate-based, an ester-based, an ether-based, a ketone-based, an alcohol-based solvent, an aprotic solvent, and may be used alone or in combination of two or more.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles such as at least one of Al₂O₃, SiO₂, TiO₂, SnO₂, CeO₂, MgO, NiO, Cao, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

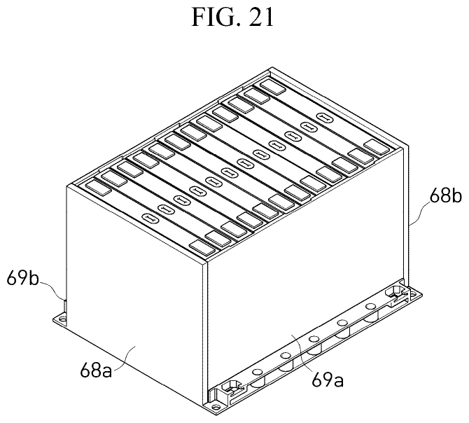

FIG. 21 is an illustration of a secondary battery module in which secondary batteries manufactured according to examples of the present disclosure are arranged. With the increase in secondary battery capacity for driving electric vehicles, and the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

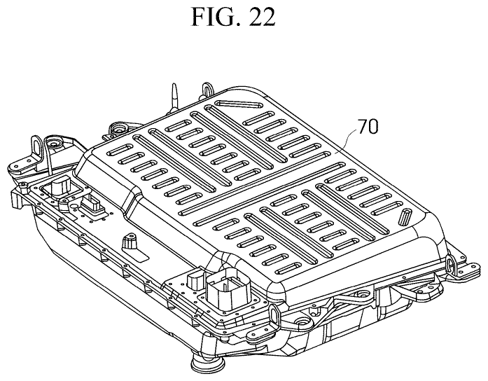

FIG. 22 is an illustration schematically showing the configuration of a battery pack 70 according to example embodiments of the present disclosure. Referring to FIG. 21, a battery pack 70 may include an assembly to which individual batteries are electrically connected, and a pack housing accommodating the same. In the drawings, for convenience of illustration, components including a bus bar, a cooling unit, external terminals for electrically connecting batteries, etc., are not shown.

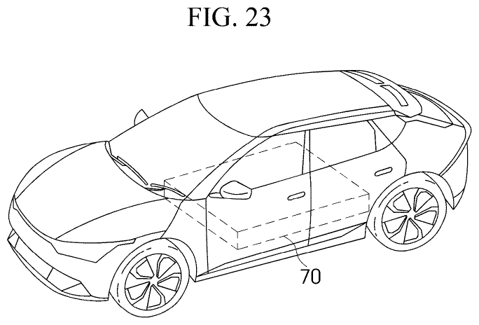

The battery pack 70 may be mounted on (or in) a vehicle. The vehicle may be, for example, an electric vehicle, a hybrid vehicle, a plug-in hybrid vehicle, and the like. The vehicle may be a four-wheeled vehicle or a two-wheeled vehicle but is not limited thereto. FIG. 23 shows a vehicle V which includes the battery pack 70 shown in FIG. 22 on the lower body thereof. The vehicle V may operate by (e.g., may be powered by) receiving power from the battery pack 70.

Although the present disclosure has been described herein with respect to example embodiments thereof, the present disclosure is not limited thereto. Various modifications and variations can be made thereto by those skilled in the art within the spirit of the present disclosure and the equivalent scope of the appended claims.

What is claimed is:

1. A method of confirming a swelling of a secondary battery, comprising steps of:
(a) designing an index for confirming a battery swelling phenomenon of the secondary battery;
(b) disposing the index for confirming the battery swelling phenomenon of the secondary battery on a surface of the secondary battery; and
(c) confirming the battery swelling phenomenon by confirming a change of the index.

2. The method as claimed in claim 1, wherein step (a) comprises designing the index as a fiducial marker having a preset length.

3. The method as claimed in claim 1, wherein step (a) comprises designing a fiducial marker having a rectangular bar shape.

4. The method as claimed in claim 1, wherein step (a) comprises designing the index as a fiducial marker having a cross shape.

5. The method as claimed in claim 1, wherein step (a) comprises designing the index corresponding to product labeling.

6. The method as claimed in claim 5, wherein step (a) further comprises designing a preset part of a logo included in the product labeling as the index.

7. The method as claimed in claim 6, wherein step (a) further comprises determining the preset part by using text of PAD artwork.

8. The method as claimed in claim 1, wherein step (b) comprises disposing the index in a preset area by considering a deformation of appearance of the secondary battery when the battery swelling phenomenon occurs.

9. The method as claimed in claim 8, wherein step (b) comprises disposing the index in a preset area among edge areas of the secondary battery.

10. The method as claimed in claim 1, wherein step (c) comprises confirming the battery swelling phenomenon by matching a change of the index with a danger level by considering a divided item for each of a plurality of danger levels according to the swelling of the secondary battery.

11. The method as claimed in claim 10, wherein step (c) further comprises determining a degree of danger by dividing the degree of danger into division items for each danger level, comprising “normal” from a designed length of the index to a range of a first preset multiple, “caution” from the designed length of the index to a range of a second preset multiple, “warning” from the designed length of the index to a range of a third preset multiple, and “danger” from the designed length of the index to a range of a fourth preset multiple.

12. A system for confirming a battery swelling phenomenon, the system comprising:
memory in which a program that confirms a battery swelling phenomenon by using an index disposed on a surface of a battery is stored; and
a processor configured to execute the program,
wherein the processor outputs results of confirmation of the battery swelling phenomenon for each of a plurality of danger levels by considering a ratio of change of the index.

13. The system as claimed in claim 12, wherein the index is disposed on the surface of the battery as a fiducial marker having a preset length.

14. The system as claimed in claim 12, wherein the index is disposed on the surface of the battery as product labeling comprising a part having a preset length.

15. The system as claimed in claim 12, wherein the processor confirms the battery swelling phenomenon by matching the ratio of change of the index by considering a division item for each danger level according to a welling of the battery.

16. A battery device to confirm a battery swelling, comprising:
a fiducial marker disposed on a surface of the battery and having a shape changed depending on a battery swelling phenomenon.

17. The battery device as claimed in claim 16, wherein the fiducial marker is formed in a rectangular bar shape.

18. The battery device as claimed in claim 16, wherein the fiducial marker is formed in a cross shape.

19. The battery device as claimed in claim 16, wherein the fiducial marker is formed in a form of text of product labeling.

20. The battery device as claimed in claim 16, wherein the fiducial marker is disposed in a preset area by considering a deformation of appearance of the battery according to the battery swelling phenomenon.
